(19) United States
(12) Patent Application Publication
(10) Pub. No.: US 2005/0283622 A1
(43) Pub. Date: Dec. 22, 2005

(54) System for managing security index scores

(75) Inventors: Kylene Jo Hall, Austin, TX (US); Dustin C. Kirkland, Austin, TX (US); Emily Jane Ratliff, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/870,529

(22) Filed: Jun. 17, 2004

(51) Int. Cl. G06F 11/30

(52) U.S. Cl. 713/190

(57) ABSTRACT

A system for managing security index scores is provided. A security index that rates the security level of a portion of code is associated with the code. Development tools, such as packaging utilities, compilers, integrated development environments, and the like, may warn the user if the security level of the portion of the code is low. Source code repository tools, such as concurrent versioning systems, may deny submitted source code if the security index is below a threshold or below a previous version. Installation tools may warn a user or refuse to install a software package if an associated security index is low. Security index scores may be maintained and digitally signed by a trusted third party.

### CROSS REFERENCE TO RELATED APPLICATIONS

The present invention is related to an application entitled PROBABILISTIC MECHANISM TO DETERMINE LEVEL OF SECURITY FOR A SOFTWARE PACKAGE, U.S. application Ser. No. ______, Attorney Docket No. AUS920040210US1, filed even date hereof, assigned to the same assignee, and incorporated herein by reference.

### BACKGROUND OF THE INVENTION

1. Technical Field

The present invention relates to data processing and, in particular, to security of program code. Still more particularly, the present invention provides a method, apparatus, and program for management of security index scores of program code.

2. Description of Related Art

Writing secure code is something that should concern every developer. Repeatedly writing insecure code can damage a developer's reputation, particularly in the open source community. In the commercial software market, software with security vulnerabilities may suffer in sales and, thus, profitability.

Many tools exist that can be used to analyze source code for possible vulnerabilities. However, these tools may be difficult to use and analyzing the results can be tedious. Also, these existing tools do not interface well with the tools that developers commonly use. In addition, the existing tools may add time to the development process with somewhat mixed results.

Software users and system administrators also care about the security of software. Often, users have no way of knowing how secure a given piece of software is until a vulnerability for the software is publicized or exposed by an attack.

### SUMMARY OF THE INVENTION

The present invention recognizes the disadvantages of the prior art and provides a system for managing security index scores. A security index that rates the security level of a portion of code is associated with the code. Development tools; such as packaging utilities, compilers, integrated development environments, and the like, may warn the user if the security level of the portion of the code is low. Source code repository tools, such as concurrent versioning systems, may deny submitted source code if the security index is below a threshold or below a previous version. Installation tools may warn a user or refuse to install a software package if an associated security index is low. Security index scores may be maintained and digitally signed by a trusted third party.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 illustrates a software development environment in accordance with a preferred embodiment of the present invention;

FIG. 5 illustrates an example source code repository environment in accordance with a preferred embodiment of the present invention;

FIG. 6 illustrates an example software installation environment in accordance with a preferred embodiment of the present invention; and

FIG. 7 is a flowchart illustrating operation of managing security index scores for software code in accordance with a preferred embodiment of the present invention.

### DETAILED DESCRIPTION OF THE PREFERRED EMBODIMENT

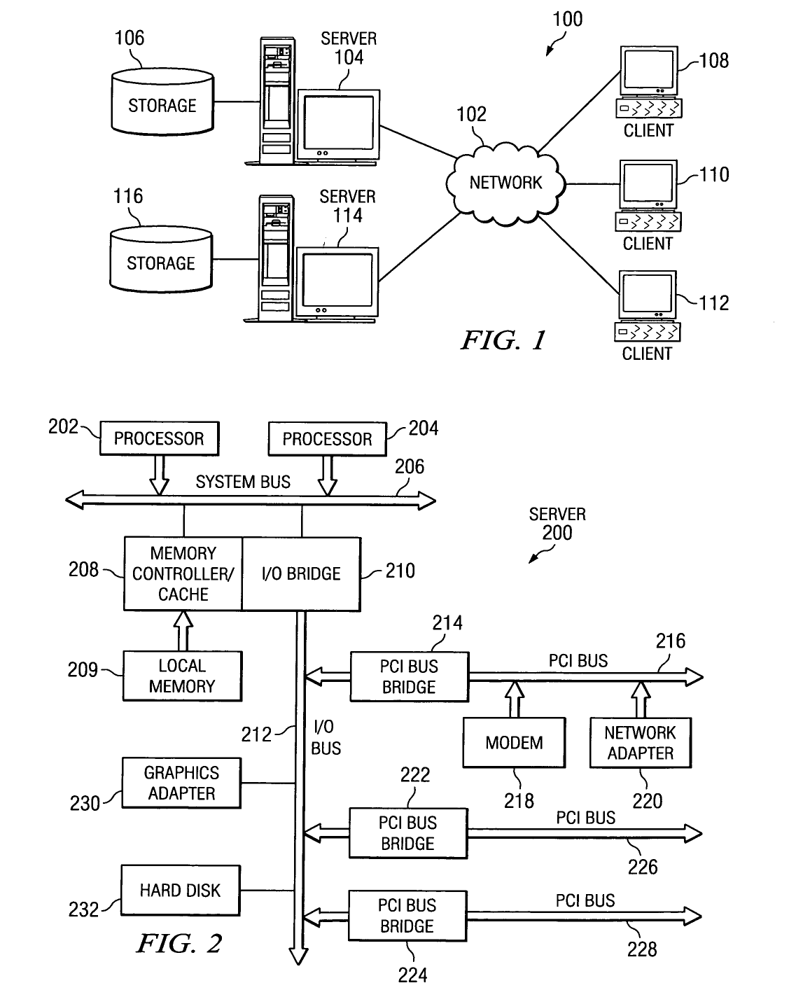

The present invention provides a method, apparatus and computer program product for management of security index scores of program code. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, servers 104, 114 are connected to network 102 and provide access to storage units 106, 116, respectively. In addition, clients 108, 110, and 112 are connected to network 102. These clients 108, 110, and 112 may be, for example, personal computers or network computers. In the depicted example, servers 104, 114 may provide data, such as boot files, operating system images, and applications to clients 108, 110, 112. Clients 108, 110, and 112 are clients to server 104. Network data processing system 100 may include additional servers, clients, and other devices not shown.

In accordance with a preferred embodiment of the present invention, a system for managing security index scores is provided. A security index that rates the security level of a portion of code is associated with the code. Development tools, such as packaging utilities, compilers, integrated development environments, and the like, may warn the user if the security level of the portion of the code is low. Source code repository tools, such as concurrent versioning systems, may deny submitted source code if the security index is below a threshold or below a previous version. Installation tools may warn a user or refuse to install a software package if an associated security index is low. Security index scores may be maintained and digitally signed by a trusted third party.

A portion of code may be, for example, source code for a project. Source code comprises programming statements and instructions that are written by a programmer. Source code is what a programmer writes, but it is not directly executable by the computer. Source code must be converted into machine language by a compiler, an assembler, or an interpreter, for example. Alternatively, machine specific or platform independent bytecode may also be associated with a security index score within the scope of the present invention. In fact, only a portion of code, such as a patch or a portion of a project, may be associated with a security index score.

One or more of clients 108, 110, 112 may be used by an operator to develop code or to install code based on a security index. A server, such as server 104, may manage a source code repository tool, such as a concurrent versioning system (CVS) for example. A source code repository may be stored in a database, such as in storage 106. A server, such as server 114, may provide a central authority that is a trusted third party for maintaining and digitally signing security index scores. The security index scores may be stored in a database, such as in storage 116.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eserver™ pseries® system, a product of International Business Machines Corporation in Armonk, N.Y., running the Advanced Interactive Executive (AIX™) operating system or LINUX operating system.

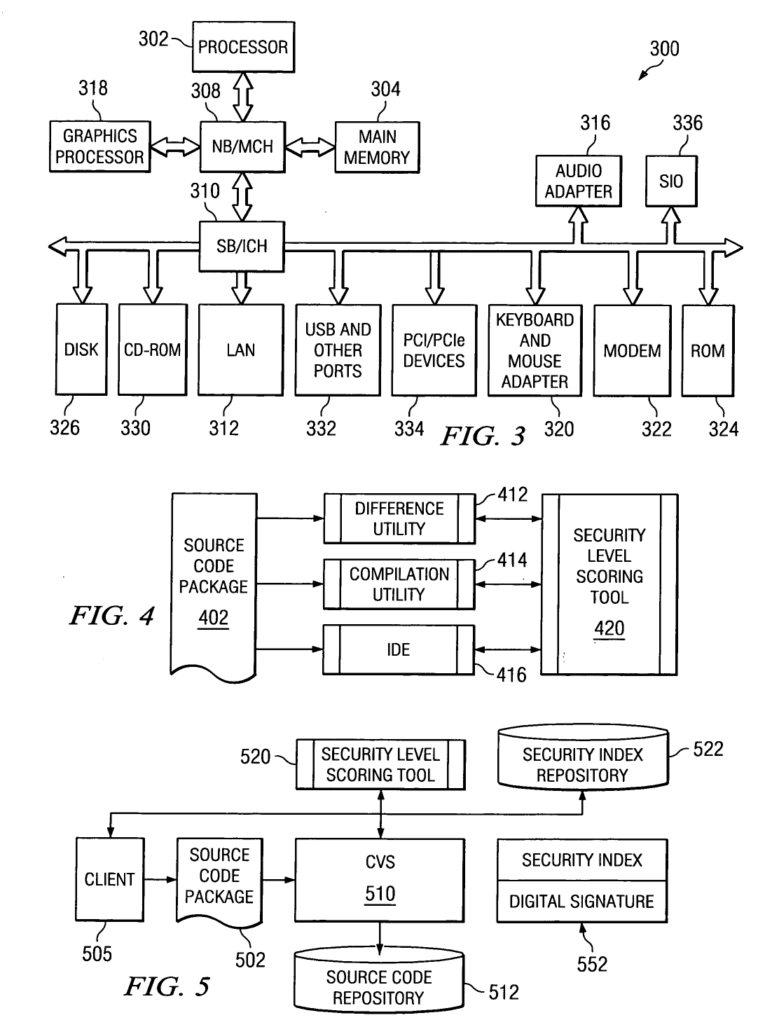

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

FIG. 4 illustrates a software development environment in accordance with a preferred embodiment of the present invention. A programmer develops source code package 402 using one or more development tools, such as a patch utility, a compilation utility, an integrated development environment (IDE), or the like.

Patch utility 412 is a tool for developers to submit code by creating a patch. One example of a commonly used patch tool is the diff utility. Patch utility 412 may receive a security index score from security level scoring tool 420. An example of a security level scoring tool is described in co-pending application ______ (Attorney Docket No. AUS920040210US1), entitled “PROBABILISTIC MECHANISM TO DETERMINE LEVEL OF SECURITY FOR A SOFTWARE PACKAGE,” which is herein incorporated by reference. Patch utility 412 may warn a developer about a patch being considered for submission if the patch has a subpar security index.

Compilation utility 414 may refuse to compile code if the security index is below a threshold, thereby saving valuable time that would be spent building insecure software. Compilation utility 414 may simply be a compiler such as gcc, for example, or a compilation utility such as the make utility, for example.

Integrated development environment (IDE) 416 may receive a security index score from security level scoring tool 420. IDE 416 may simply be a source code editor like emacs, for example. However, IDE 416 may include a set of programs run from a single user interface, such as a text editor, compiler, and debugger. IDE 416 may use the security index to color code vulnerabilities, for example.

Other developer tools may also use a security index score. For example, a source code repository client may refuse to submit code if the index is not above a permissible threshold as configured by the user. Also, the developer tools may receive a security index score from a trusted third party. A central authority may store software packages along with the security index scores. In addition, the central authority may store a hash for the software package in association with the security index score for purposes of validation.

FIG. 5 illustrates an example source code repository environment in accordance with a preferred embodiment of the present invention. A developer may submit source code package 502 to a source code repository, such as concurrent versioning system (CVS) 510, using client 505. CVS 510 maintains source code repository 512. Client 505 may be, for example, a client device, such as a general purpose computer; or a client application used by a developer for developing and/or managing source code. In one-preferred embodiment, client 505 is a CVS client application for communicating with CVS 510 or, more particularly, for submitting source code to CVS 510. In an exemplary embodiment, source code package 502 is a source tree for a project. A source tree is an entire directory structure for the source code of a project.

When the developer is ready to submit source code package 502, client 505 may obtain a security index score for the source code package from security level scoring tool 520, for instance. Alternatively, client 505 may obtain the security index score from security index repository 522. In one preferred embodiment, client 505 may determine whether to submit source code package 502 to CVS 510 based on the security index score. For example, if the security index is below a critical threshold, client 502 may refuse to submit the source code package. Client 502 may also warn the developer of the security index score before source code package 502 is submitted. The developer may then control whether a source code package with a subpar security index score is submitted to the source code repository, thus giving the developer more control over submissions that may affect his or her reputation.

Similarly, CVS 510 may determine whether to accept source code package based on the security index score of source code package 502. The security index score may be sent to CVS 510 with the source code package itself. However, CVS 510 may receive the security index score from security level scoring tool 520 or security index repository 522. CVS 510 may refuse to check in code if the security index is not above a permissible threshold. CVS 510 may also warn the developer if the security index is below a predetermined threshold or if the security index is below that of the previous version of the project. Thus, CVS 510 may ensure that the security index for a project improves as the project evolves or is at least above an acceptable threshold.

CVS 510 may also post the security index score of source code packages in source code repository 512. Thus, developers who consistently produce code with high security scores will establish a better reputation in the industry.

The security index scores themselves may be maintained in security index repository 522, which may be managed by a centralized trusted third party. Each security index may be digitally signed by the trusted third party. The trusted third party may sign the security index using a public/private key technique. The trusted third party signs the security index using a private key.

As an example, CVS 510 may obtain security index 552 for source code package 502. Security index 552 includes a digital signature of the trusted third party, which is based on a hash of the source code and/or the security index. Therefore, when a security index is received from security index repository 522, one can verify that the security index is signed by the trusted third party. One may then form a hash of the source code and/or the security index score and compare that hash to that of the security index from the security index repository. The hash from the repository may be obtained, for example, by decrypting the security index using a public key of the trusted third party. One may then verify that the source code package or the security index has not been modified by comparing the hash values.

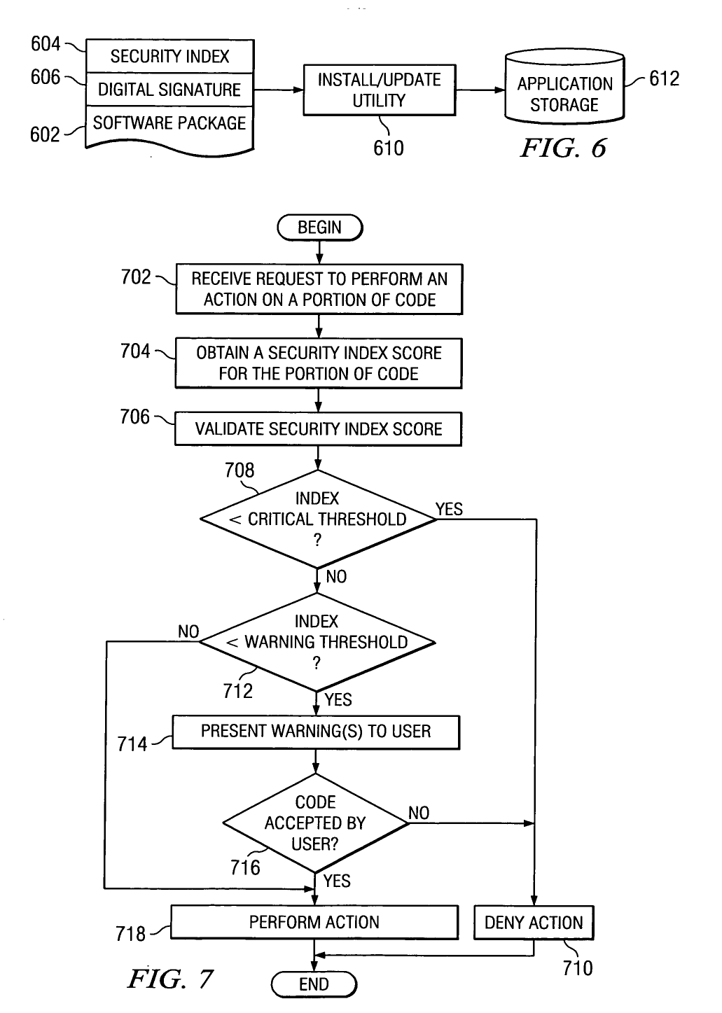

FIG. 6 illustrates an example software installation environment in accordance with a preferred embodiment of the present invention. Install/update utility 610 receives software package 602 for installation to application storage 612. The software package 602 may be, for example, an application installation, an application update, an operating update, a security fix, or the like.

As illustrated in FIG. 6, the software package 602 may be associated with security index 604 and digital signature 606, which may accompany software package 602 or may be obtained from a central authority, as described above. Install/update utility 610 may be a package manager, such as rpm, apt, InstallShield®, or the like.

Before installing software package 602, install/update utility 610 may validate security index 604 by authenticating digital signature 606 and validating that security index 604 and software package 602 have not been modified. Install/update utility 610 may also compare the security index score of software package 602 to a predetermined threshold or a security index score of a previous version of the software in application storage 612. Install/update utility 610 may maintain a registry (not shown) of software applications installed in application storage 612, their versions, and their security index scores.

Install/update utility 610 may then ensure that the security index for software applications generally increase or at least remain above an acceptable threshold. If the security index 604 is not above a critical threshold, install/update utility 610 may refuse to install software package 602 to application storage 612. If the security index 604 is not above a warning threshold, install/update utility 610 may warn the user of the security level of the software package and prompt the user for instructions as to whether to continue installation. Furthermore, install/update utility 610 may warn the user if security index 604 is not above a previous version of the software package in application storage 612. Install/update 610 may refuse to install the update, for example, software package 602 is a security update, but does not improve the security of the software.

FIG. 7 is a flowchart illustrating operation of managing security index scores for software code in accordance with a preferred embodiment of the present invention. The process begins and receives a request to perform an action on a portion of code (block 702). An action may be, for example, compiling the code, preparing a patch, submitting the code to a source code repository, checking in code at a source code repository, installing the code, etc.

The process obtains a security index score for the portion of code (block 704). The security index score may be received from a security level scoring tool, from a source of the portion of code, or from a trusted third party. Then, the process validates the security index score (block 706).

A determination is made as to whether the security index is less than a critical threshold (block 708). If the security index is less than a critical threshold, the process denies the action (block 710). Thereafter, the process ends.

If the security index is not less than the critical threshold in block 708, a determination is made as to whether the security index is less than a warning threshold (block 712). The warning threshold may be a predetermined value. Alternatively, the warning threshold may be a security index score of a previous version of the portion of code. In another alternative embodiment, the process may compare the security index to both a predetermined threshold and a security index score of a previous version of the portion of code. If the security index is less than the warning threshold, the process presents a warning to the user (block 714).

A determination is made as to whether the user accepts the code in response to the warning (block 716). If the user does not accept the code, the process returns to block 710 and denies the action. If, however, the user accepts the code in block 716, or if the index is not less than the warning threshold in block 712, the process performs the requested action (block 718). Thereafter, the process ends.

Thus, the present invention solves the disadvantages of the prior art by providing a system for managing security index scores. A security index that rates-the security level of a portion of code is associated with the code. Development tools, such as packaging utilities, compilers, integrated development environments, and the like, may warn the user if the security level of the portion of the code is low. Source code repository tools, such as concurrent versioning systems, may deny submitted source code if the security index is below a threshold or below a previous version. Installation tools may warn a user or refuse to install a software package if an associated security index is low. Security index scores may be maintained and digitally signed by a trusted third party.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for managing installation of software code based on security level of a computer system, the method comprising:
receiving a request to install a package of software on the computer system;
deriving from a security index associated with the package of software code a security index score for the package of software code; and
determining whether to permit the install of the package of software code based on a comparison between the security index score and a security threshold specified for the computer system.

2. The method of claim 1, wherein deriving a security index score includes receiving the security index from a trusted third party.

3. The method of claim 2, wherein the security index is digitally signed by the trusted third party.

4. The method of claim 1, wherein the install includes one of compiling the package of software code, preparing a patch for the package of software code, submitting the package of software code to a source code repository, checking in the package of software code at a source code repository, and installing the package of software code to a persistent storage.

5. The method of claim 1, wherein determining whether to permit the install includes:
responsive to the security index score having a predetermined relationship to the security threshold, denying the install.

6. The method of claim 1, wherein determining whether to permit the install includes:
responsive to the security index score having a predetermined relationship to the security threshold, presenting a warning to a user.

7. The method of claim 6, wherein the warning prompts the user to indicate whether to permit the install.

8. The method of claim 1, wherein determining whether to permit the install includes:
responsive to the security index score having a predetermined relationship to the security threshold, permitting the install.

9. The method of claim 1, wherein the security threshold is a score for a previous version of the package of software code.

10. A computer program product, in a computer readable medium, for managing installation of software code based on security level of a computer system, the computer program product comprising:
instructions for receiving a request to install a package of software on the computer system;
instructions for deriving from a security index associated with the package of software code a security index score for the package of software code; and
instructions for determining whether to permit the install of the package of software code based on a comparison between the security index score and a security threshold specified for the computer system.

11. The computer program product of claim 10, wherein the instructions for deriving a security index score include instructions for receiving the security index from a trusted third party.

12. The computer program product of claim 11, wherein the security index is digitally signed by the trusted third party.

13. The computer program product of claim 10, wherein the install includes one of compiling the package of software code, preparing a patch for the package of software code, submitting the package of software code to a source code repository, checking in the package of software code at a source code repository, and installing the package of software code.

14. The computer program product of claim 10, wherein the instructions for determining whether to permit the install include:
instructions, responsive to the security index score having a predetermined relationship to the security threshold, for denying the install.

15. The computer program product of claim 10, wherein the instructions for determining whether to permit the install include:
instructions, responsive to the security index score having a predetermined relationship to the security threshold, for presenting a warning to a user.

16. The computer program product of claim 15, wherein the warning prompts the user to indicate whether to permit the install.

17. The computer program product of claim 10, wherein the instructions for determining whether to permit the install include:
instructions, responsive to the security index score having a predetermined relationship to the security threshold, for permitting the install.

18. The computer program product of claim 10, wherein the security threshold is a score for a previous version of the package of software code.

19. An apparatus for managing installation of software code based on security level of a computer system, the apparatus comprising:
means for receiving a request to install a package of software on the computer system;
means for deriving from a security index associated with the package of software code a security index score for the package of software code; and
means for determining whether to permit the install of the package of software code based on a comparison between the security index score and a security threshold specified for the computer system.

20. The apparatus of claim 19, wherein the install includes one of compiling the package of software code, preparing a patch for the package of software code, submitting the package of software code to a source code repository, checking in the package of software code at a source code repository, and installing the package of software code to a persistent storage.
